(19) United States
(12) Patent Application Publication
(10) Pub. No.: US 2010/0122400 A1
(43) Pub. Date: May 20, 2010

(54) HEADWEAR AND FOOTWEAR WITH A FLEXIBLE WOOD VENEER

(76) Inventor: Matthew O. Nelson, Kapaa, HI (US)

Correspondence Address: Kristina M. Grasso;Kristina M. Grasso, Esq. PLLC, P.O. Box 162, Milford, NH, 03055, US

(21) Appl. No.: 12/692,576

(22) Filed: Jan. 22, 2010

Related U.S. Application Data
(63) Continuation-in-part of application No. 12/111,201, filed on Apr. 29, 2008.

(51) Int. Cl. A42B 1/00; A43B 1/06; A43B 3/12; B23P 17/04

(52) U.S. Cl. 2/195.1; 2/200.1; 36/86; 36/11.5; 29/428

(57) ABSTRACT

A visor and/or sandal straps that are flexible and may be shaped and bent without cracking is provided. A flexible wood veneer layer is positioned over the visor and/or strap. A layer of engineered paperbacked wood veneer is used to cover the visor and/or strap. This single layer of thin wood veneer with the attached adhesive paper is able to flex and bend using a process that involves a breaking down of the natural fibers of the wood through a mechanical tenderizing process. This process produces a flexible, bendable paperbacked veneer. The wood veneer may be obtained from tropical or domestic tree species. The wood veneer layer is then attached to the visor and/or strap with a flexible water-based adhesive that will not crack on bending. The veneer layer may be treated with a waterproofing agent or scented essential oils and may have an ornamental design.

### RELATED APPLICATIONS

This application claims the benefit of U.S. application Ser. No. 12/111,201 filed Apr. 29, 2008, which is herein incorporated in its entirety by reference.

### TECHNICAL FIELD

This invention relates to headwear and footwear. More particularly, this invention relates to headwear and footwear having a flexible wood veneer on the visor and straps, respectively.

### BACKGROUND

A baseball cap is a type of soft cap with a long, stiff visor that may either be curved or flat. The back of the cap may have a plastic, hook and loop, or elastic adjuster so that it can be quickly adjusted to fit different wearers. Traditionally, the visor is worn forward, shielding the eyes of the wearer from the sun, but it is also often worn backwards or at other angles. Baseball caps are normally sewn in six sections, and may be topped with a matching fabric-covered button on the crown. Metal grommets or fabric eyelets are often sewn or attached near the top of each of the six sections of fabric to provide ventilation. In some cases, the rear sections of the crown are made of net-like mesh material for extra ventilation. The bill is typically stiffened by a sewn-in piece of paperboard and/or cardboard. Baseball caps are made of many types of material and shaped in various styles for different purposes.

In spite of their popularity, baseball hats suffer from design flaws. For example, because the visor usually employs a layer of cardboard, i.e., an “insert board”, to provide the requisite stiffness, baseball hats are susceptible to water-damage. Specifically, because of the water-degradable nature of the visor, water contact causes the visor to buckle, degrade, or otherwise become unsightly. Furthermore, baseball hats are typically sold with an unformed or flat visor, thus requiring the wearer to initially shape and continually reshape the visor so as to adequately shade the face of the wearer. Finally, baseball hats have a limited lifespan due to the poor durability of the insert board material, i.e.: the visor is susceptible to rips or tears.

In order to maintain the shape of the visor, other materials, such as plastics, and other devices, such as braces, have been used. However, this results in loss of flexibility of the visor.

Sandals and/or flip-flops are an open type of outdoor footwear, consisting of a sole held to the wearer's foot by straps passing over the instep. They are a very basic type of footwear. They consist essentially of a sole with two simple straps running in a Y shape from the sides of the foot to the join between the big toe and next toe. Some include a strap along the back heel. The straps may be made from a variety of natural or synthetic fabrics and textures, such as leather, rubber, nylon, vinyl, and heavy fabric. The straps may also be adorned with decorative jewels.

### SUMMARY

The present invention overcomes the disadvantages of the prior art by providing a visor and/or sandal straps that are flexible and may be shaped and bent without cracking. In addition, they are water-resistant, durable, and aesthetically pleasing. Specifically, the aforementioned advantages are achieved by positioning a flexible wood veneer layer over the visor and/or strap. In this way, the wood veneer layer is the external, visible layer.

In one embodiment, one layer of engineered paperbacked wood veneer is used to cover the visor and/or strap. This single layer of thin wood veneer with the attached adhesive paper is able to flex and bend using a process that involves a breaking down of the natural fibers of the wood through a mechanical tenderizing process. This mechanical tenderizing process produces a flexible, bendable paperbacked veneer. The wood veneer may be obtained from a tropical or domestic tree species.

The wood veneer layer is then attached to the visor and/or strap with a flexible water-based adhesive that will not crack on bending. In another embodiment, the wood veneer layer may be treated with a waterproofing agent in order to provide the visor and/or strap with water-repellent properties. This may be a clear coating of water-based polyurethane or similar water-based finishes.

In an alternative embodiment, the wood veneer layer may be treated with scented essential oils. In another alternative embodiment, the visor and/or strap may include an ornamental design.

The features and advantages described herein are not all-inclusive and, in particular, many additional features and advantages will be apparent to one of ordinary skill in the art in view of the drawings, specification, and claims. Moreover, it should be noted that the language used in the specification has been principally selected for readability and instructional purposes, and not to limit the scope of the inventive subject matter.

### BRIEF DESCRIPTION OF THE DRAWINGS

FIG. 1 is a side view of the headwear of the present invention, specifically the visor.

FIG. 2 is a perspective view of the headwear of the present invention, specifically the visor.

FIG. 3 is an exploded view of the visor of the present invention showing the two piece construction.

FIG. 4 is a top view of the footwear of the present invention, specifically the straps.

FIG. 5 is a front view of the footwear of the present invention, specifically the straps.

FIG. 6 is a perspective view of the footwear of the present invention, specifically the straps.

FIG. 7 is an exploded view of the straps of the present invention showing the two piece construction.

### DETAILED DESCRIPTION

Veneer refers to thin slices of wood. Veneer is obtained either by “peeling” the trunk of a tree or by slicing large rectangular blocks of wood known as flitches. Paper backed veneer is as the name suggests, veneers that are backed with a paper. The advantage to this is it is available in large sizes, or sheets, as smaller pieces are joined together prior to adding the backing. This is also helpful when veneering curves and columns as the veneer is less likely to crack. There are a number of “patterns” common to veneered work. This refers to the way the veneers are laid up. A book matched pattern is where the veneers are opened from the flitch much like the pages of a book.

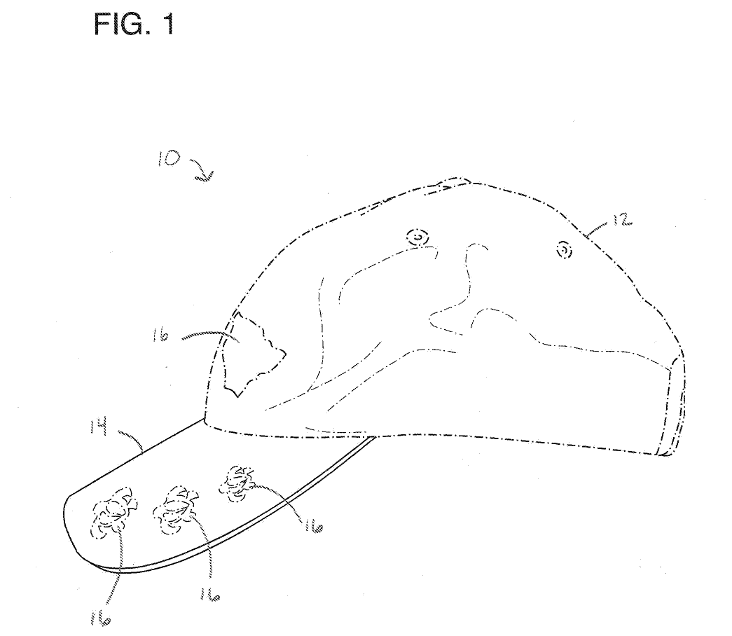

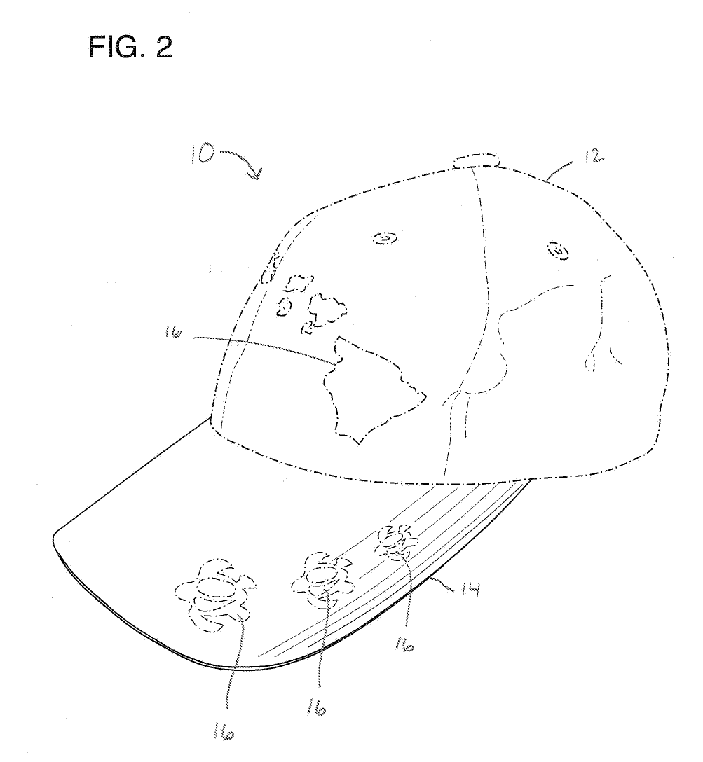

Referring to FIGS. 1 and 2, a cap 10 is shown. Cap 10 has a head encompassing portion 12 and a visor 14. In one embodiment, cap 10 is a baseball cap. In alternative embodiments, cap 10 may be other styles of headwear, including but not limited to, fedoras, sun hats, pork pie hats, newsboy caps, and/or sports visors. In one embodiment, head encompassing position 12 and visor 14 may include an ornamental design 16.

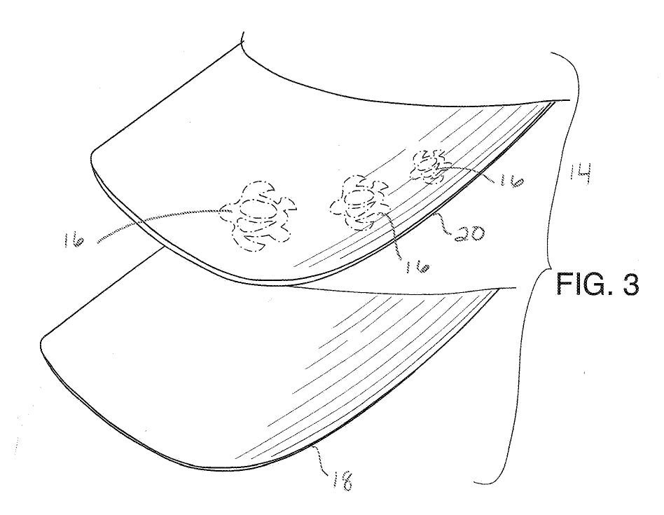

Referring to FIG. 3, visor 14 has two parts: base layer 18 and veneer layer 20. In one embodiment, veneer layer 20 is a single layer of engineered flexible paper backed veneer. This single layer of veneer with the attached adhesive paper is able to flex and bend using a process that involves a breaking down of the natural fibers of the wood by a mechanical tenderizing process. This process produces a flexible, bendable paper backed veneer. An example of a commercially available flexible engineered wood veneer product suitable for use in the present invention is “EquaFlex”, available from Superior Veneer. The thickness of the paper backed flexible veneer product ranges from 1/16 inch to 1/42 inch. In the woodworking industry, veneer thickness is commonly referred to in “miL” units. In one embodiment of the present invention, a paper backed veneer product ranging from 10-40 miL may be used.

Veneer layer 20 may be any type of wood that has gone through the paper backing manufacturing process. Woods suitable for use as veneer layer 20 include, but are not limited to, tropical woods such as: Hawaiian koa, Brazilian koa, eucalyptus, camphor, ebony, sapele, African angire, teak, or lacewood, or domestic woods such as: oak, walnut, maple, cherry, mahogany, or pine. In one embodiment, veneer layer 20 may be positioned on base layer 18 as one solid wood grain pattern. In an alternative embodiment, veneer layer 20 may be positioned on base layer 18 with a seam down the middle, e.g. in a book matched pattern, such that the grain pattern on the left side of veneer layer 20 is a mirror image of the grain pattern on the right side of veneer layer 20.

Veneer layer 20 is cut from a larger sheet of wood veneer to fit the shape of base layer 18. Veneer layer 20 is sanded until smooth, then a layer of shellac or sanding sealer is brushed or sprayed on veneer layer 20 to seal and fill the pores of veneer layer 20. In addition to sealing the wood, the sealer highlights tones and colors of the wood. Veneer layer 20 is then sanded again, and a clear layer of water-based polyurethane is applied to seal and protect veneer layer 20 from water, sun, dirt, or grease. The water-based polyurethane, referred to as “polycrylic” allows for flexibility of veneer layer 20.

Veneer layer 20 is attached to base layer 18 of visor 14 using a water-based adhesive. An example of a commercially available water-based adhesive suitable for use in the present invention is Wilsonart® H2O water-based contact adhesive.

When veneer layer 20 is attached to base layer 18, visor 14 may be bent and shaped to a desired curvature, ranging from 0 to 110 degrees.

In addition to providing an aesthetically pleasing wood grain appearance, veneer layer 20 provides a durable surface upon which an ornamental design 16, such as a company symbol, insignia, or trademark that is visible on the wood surface, may be affixed. Ornamental design 16 may be etched, burned, painted, or silkscreened onto veneer layer 20. In an alternative embodiment, veneer layer 20 may be treated with scented essential oils to provide the wearer with an aromatherapy experience.

Head encompassing portion 12 and base layer 18 of visor 14 may be constructed in accordance with any known method and of any desirable material. Example materials may consist of but are not limited to: cotton, polyester blends, microfiber, hemp, and organic cotton. Head encompassing portion 12 may be made in different sizes to fit a variety of wearers. Head encompassing portion 12 may incorporate an adjustment means so that cap 10 will fit the circumference of the head of a variety of wearers. The adjustment means may be an elastic band, tab and slot adjustment straps, and/or hook and loop fasteners.

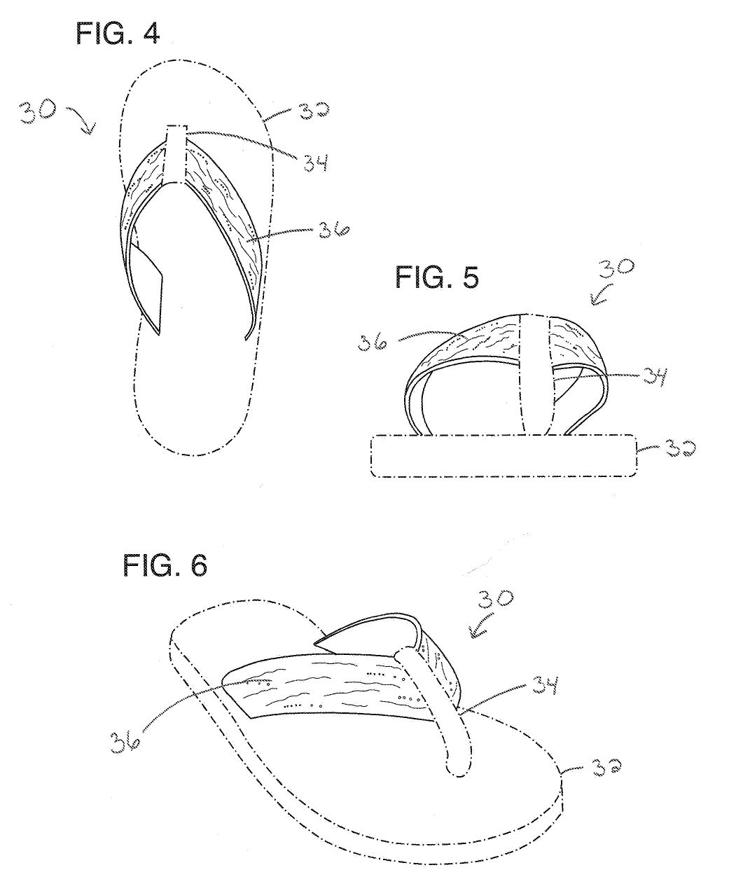

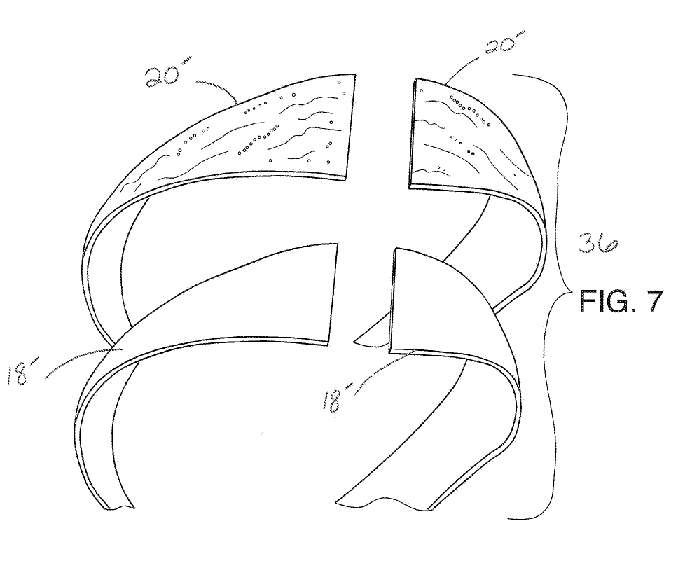

An alternative embodiment is shown in FIGS. 4-6. Sandal 30 has a base 32, a toe separator 34, and a strap 36. In one embodiment, sandal 30 is a flip flop. In alternative embodiment, sandal 30 may be other styles of footwear, such sports sandals and/or dress sandals.

Referring to FIG. 7, strap 36 has two parts: base layer 18′ and veneer layer 20′. As discussed with respect to FIG. 3, veneer layer 20′ is a single layer of engineered flexible paper backed veneer, may be any type of wood that has gone through the paper backing manufacturing process, undergoes the same sanding and sealing process, and is attached to base layer 18′ using a water based adhesive.

In one embodiment, veneer layer 20′ may be positioned on base layer 18′ in two pieces, one on each side of toe separator 34. In an alternative embodiment, veneer layer 20′ may be affixed to base layer 18′ as one piece.

When veneer layer 20′ is attached to base layer 18′, strap 36 may be bent and shaped to a desired curvature. An ornamental design may also be applied to strap 36. Strap 36 may be made from a variety of natural or synthetic fabrics and textures, such as leather, rubber, nylon, vinyl, and heavy fabric.

The foregoing has been a detailed description of illustrative embodiments of the invention. Various modifications and additions can be made without departing from the spirit and scope if this invention. Each of the various embodiments described above may be combined with other described embodiments in order to provide multiple features. Furthermore, while the foregoing describes a number of separate embodiments of the apparatus and method of the present invention, what has been described herein is merely illustrative of the application of the principles of the present invention. Accordingly, this description is meant to be taken only by way of example, and not to otherwise limit the scope of this invention.

What is claimed is:

1. An article of headwear comprising:
a head encompassing portion; and
a visor, the visor further comprising a base layer and a veneer layer.

2. The article of headwear of claim 1 wherein the veneer layer is a single layer of a paper backed wood veneer.

3. The article of headwear of claim 1 wherein the veneer layer is flexible.

4. The article of headwear of claim 1 wherein the veneer layer ranges from 1/16 inch to 1/42 inch.

5. The article of headwear of claim 1 wherein the veneer layer is made of a wood selected from the group consisting of tropical wood species and domestic wood species.

6. The article of headwear of claim 1 wherein the veneer layer is attached to the base layer by a water based adhesive.

7. The article of headwear of claim 1 wherein the veneer layer is coated with a waterproofing agent.

8. The article of headwear of claim 1 wherein the visor has a curvature range of 0 to 110 degrees.

9. The article of headwear of claim 1 wherein the veneer layer further comprises an ornamental design.

10. The article of headwear of claim 1 wherein the veneer layer is treated with a scented essential oil.

11. An article of footwear comprising:
a base for support a foot of a wearer;
a toe separator; and
a strap, the strap further comprising a base layer and a veneer layer.

12. The article of footwear of claim 11 wherein the veneer layer is a single layer of a paper backed wood veneer.

13. The article of footwear of claim 11 wherein the veneer layer is flexible.

14. The article of footwear of claim 11 wherein the veneer layer ranges from 1/16 inch to 1/42 inch.

15. The article of footwear of claim 11 wherein the veneer layer is made of a wood selected from the group consisting of tropical wood species and domestic wood species.

16. The article of footwear of claim 11 wherein the veneer layer is attached to the base layer by a water based adhesive.

17. The article of footwear of claim 11 wherein the veneer layer is coated with a waterproofing agent.

18. A method of constructing a visor for an article of headwear comprising:
forming a piece of veneer to an appropriate shape of a base layer of the visor;
sanding the piece of veneer;
applying a layer of shellac to the piece of veneer;
resanding the piece of veneer;
applying a layer of a waterproofing agent to the piece of veneer; and
attaching the piece of veneer to the base layer of the visor.

19. The method of claim 18 further comprising:
bending the visor into a curved shape.

20. A method of constructing a strap for an article of footwear comprising:
forming a piece of veneer to an appropriate shape of a base layer of the strap;
sanding the piece of veneer;
applying a layer of shellac to the piece of veneer;
resanding the piece of veneer;
applying a layer of a waterproofing agent to the piece of veneer; and
attaching the piece of veneer to the base layer of the strap.
